(19) United States
(12) Patent Application Publication
(10) Pub. No.: US 2009/0115587 A1
(43) Pub. Date: May 7, 2009

(54) Single-Chip Microcomputer Controller for Automobile Instruments

(76) Inventor: Xiuyu Che, Zhu Cheng (CN)

Correspondence Address: GLOBAL IP SERVICES, 7285 W. Eagle Court, Winton, CA, 95388, US

(21) Appl. No.: 11/934,887

(22) Filed: Nov. 5, 2007

(51) Int. Cl. B60C 23/00

(52) U.S. Cl. 340/438

(57) ABSTRACT

This invention makes known by the single-chip microcomputer controller for the automobile instruments. Its characteristic is that that one port of the presetting parameters keyboard links with the master chip, another port is grounded. One port of the presetting parameters switch links with the master chip, another port is grounded. The master chip links with many signal lines to collect the analog signal, the digital signal and the switch signal. Through the above presetting, the present invention makes the automobile instruments not only adapt various car sensors, but also adapt different parameters. So the invention makes the automobile instruments adapt various cars.

### FIELD OF THE INVENTION

The present invention relates to a single-chip microcomputer controller for the automobile instruments.

### BACKGROUND OF THE INVENTION

Nowadays the cars adopt the single-chip microcomputer controlling the automobile instruments in China. The automobile instruments are produced for aiming at the single parameter of one sensor. But lots of physical values need to be detected and showed, for example, the mileage of cars, the rational speed of engine, the temperature of the water tank, the capacity of the burned fuel and the pressure of the gas etc; the capable parameters which belong different physical values are different, for example, the rational speed rate and the pairs of poles are not the same. There are different parameters of the sensor. The automobile instruments should have the digital devices which have the relevant parameters, so that the exploitation, the production, stocking up and availability are problems.

### SUMMARY OF THE INVENTION

The object of the present invention is solving the above shortages. It also provides the single-chip microcomputer controller which could match any capable parameters of the physical values.

In order to get the above object, the present invention contains the shell of the controller, the panel which is on the shell, and the electronic circuit board in the shell. Its characteristic is that one port of the presetting parameters keyboard links with the master chip, another port is grounded. One port of the presetting parameters switch links with the master chip, another port is grounded. The master chip links with many signal lines to collect the analog signal, the digital signal and the switch signal.

Through the above presetting, the master chip of the present invention links the presetting parameters switch. When the switch is on, the state is presetting the parameters. When the switch is off, the state is running. The master chip links the presetting parameters keyboard, the sensor quantitative parameters of the automobile instruments can be changed by the keyboard. So the automobile instruments not only adapt various automobile sensors, but also adapt the different parameters. From this the automobile instruments can adapt various automobiles.

### BRIEF DESCRIPTION OF THE DRAWINGS

The present invention will be better understood from reading the following drawings:

FIG. 1 illustrates the shell of the controller.

FIG. 2 illustrates the circle diagram of the present invention.

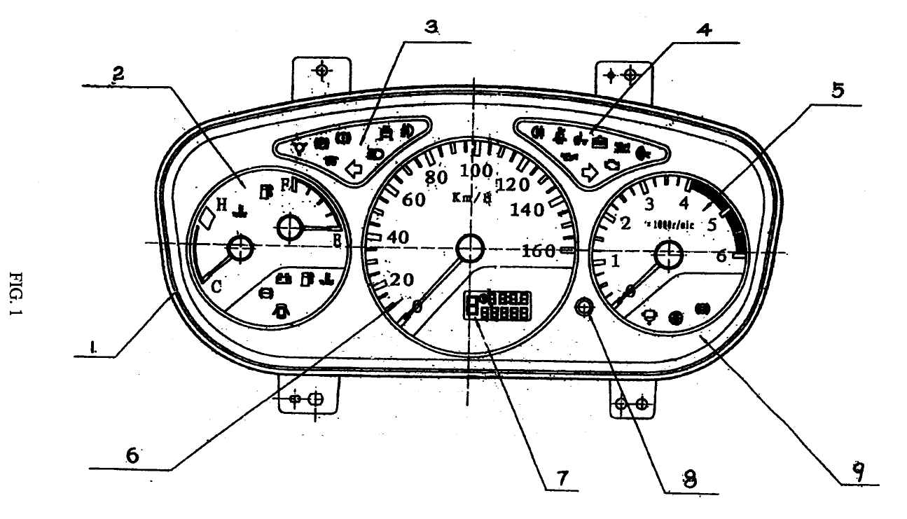

In FIG. 1, 1. Panel, 2. The capacity of fuel and the temperature of water instrument, 3. Left symbol district, 4. Right symbol district, 5. Rational speed instrument, 6. Speed and mileage instrument, 7. LCD screen, 8. Regulating pole, 9. Screen plate.

### DETAILED DESCRIPTION OF THE INVENTION

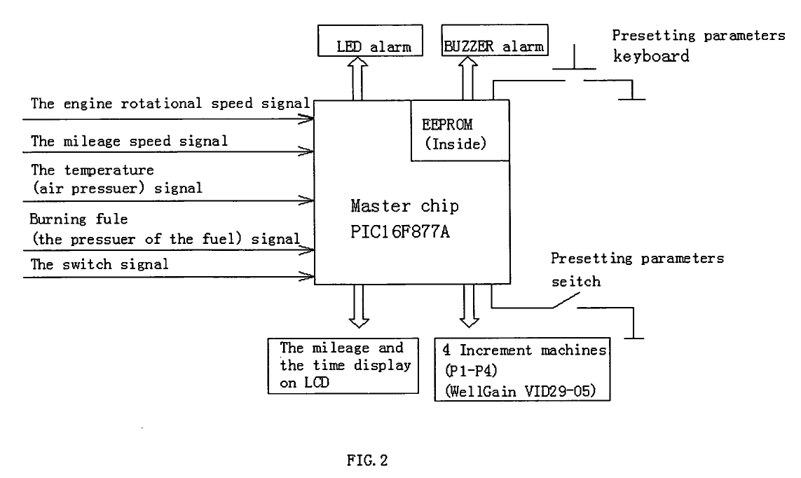

According to FIG. 1 and FIG. 2, the single-chip microcomputer, which is for the automobile instruments, contains the shell of the controller, panel 1 on the shell, the capacity of fuel and the temperature of water instrument 2 on the panel 1, left symbol district 3, right symbol district 4, rational speed instrument 5, speed and mileage instrument 6, LCD screen 7, regulating pole 8, screen plate 9. In the shell of the controller, the electronic circuit board, which comprises the master chip, some increment machines, the buzzer, some alarm LCD lights, the LCD screen, the presetting parameters switch, the presetting parameters keyboard, EEPROM; the master chip links with the increment machines, the LCD screen, the alarm LCD lights, the buzzer respectively; EEPROM is in the master chip; One port of the presetting parameters keyboard links with the master chip, another port is grounded. One port of the presetting parameters switch links with the master chip, another port is grounded. The master chip links with many signal lines to collect the analog signal, the digital signal and the switch signal.

The digital signal is mainly made of the speed of mileage instrument, the rotational speed of the engine and the water limit switch. The switch signal is mainly made of the high beam, the dipped headlight, parking light, the differential speed between axles, the exiting air brake. The capacity of fuel and the temperature of water instrument, left symbol district, right symbol district, rational speed instrument, speed and mileage instrument, the LCD screen, regulating pole and screen plate are on the control panel.

What is claimed is:

1. The single-chip microcomputer controller for the automobile instruments comprising a shell of the controller, a panel which is on the shell, and the electronic circuit board in the shell; wherein one port of the presetting parameters keyboard links with the master chip, another port is grounded; One port of the presetting parameters switch links with the master chip, another port is grounded; The master chip links with many signal lines to collect the analog signal, the digital signal and the switch signal.
